(19) United States
(12) Patent Application Publication
(10) Pub. No.: US 2004/0136414 A1
(43) Pub. Date: Jul. 15, 2004

(54) Wavelength-tunable semiconductor optical device

(75) Inventors: Keisuke Matsumoto, Tokyo (JP); Hitoshi Tada, Tokyo (JP)

Correspondence Address: LEYDIG VOIT & MAYER, LTD, 700 THIRTEENTH ST. NW, SUITE 300, WASHINGTON, DC, 20005-3960, US

(73) Assignee: Mitsubishi Denki Kabushiki Kaisha, Tokyo (JP)

(21) Appl. No.: 10/742,830

(22) Filed: Dec. 23, 2003

(30) Foreign Application Priority Data
Jan. 15, 2003 (JP) 2003-006900

(51) Int. Cl. H01S 3/10

(52) U.S. Cl. 372/20

(57) ABSTRACT

A wavelength-tunable semiconductor optical device includes a resonator-dedicated semiconductor laser having a waveguide structure formed on a semiconductor substrate (11) and a movable mirror (4) movable in the direction of a resonator length of the semiconductor laser. The movable mirror is provided on one end face (2a) of the waveguide of the semiconductor laser. A resonator length of the semiconductor laser is varied in accordance with a movement amount of the movable mirror, so that a laser oscillation wavelength is rendered tunable. The movable mirror is formed of a pair of thin metal films (4a, 4b) opposing each other via an air gap (4d).

### BACKGROUND OF THE INVENTION

1. Field of the Invention

The present invention generally relates to a semiconductor optical device in which an optical device such as a wavelength-tunable semiconductor laser is formed on a semiconductor chip. More specifically, the invention relates to a wavelength-tunable semiconductor optical device having a wavelength-tunable laser generating a laser beam of an arbitrarily tunable wavelength in a semiconductor laser which is used as a transmitter device in an optical wavelength multiplex communication system.

2. Description of the Related Art

Conventionally, various circuit devices are formed over a semiconductor chip to build a monolithic integrated circuit configuration, thereby implementing improvements in miniaturization, reliability, and productivity. Concurrently, optical communication networks using optical fibers are indispensably required to meet requirements for handling a vast amount of communication data involved in enhancement in performance of information communication equipments. Optical devices of various types using semiconductor materials are constituted of materials of a same group. Accordingly, in an optical communication network, high-speed, small, and integratable semiconductor optical waveguides are widely used as optical communication lines. In the detailed description of the invention, the terminology “semiconductor optical device” is referred to a constituent formed such that various semiconductor optical devices are combined and integrated in a same semiconductor chip substrate.

In recent years, a great deal of attention has been paid to a wavelength division multiplex (WDM) technology that enhances an optical-fiber transmission capacity. Use of the WDM technology enables the transmission capacity of a disposed optical fiber to be enhanced several tens of times or higher. Distributed feedback semiconductor lasers or distributed feedback laser diodes (DFB-LDs)) are used as light sources in a WDM communication system. In this case, however, the DFB-LD laser has problems in that oscillation wavelengths need to be equalized to have uniform intervals, i.e., normally, gaps of 0.4 nm (nanometers) or 0.8 nm, in a wide wavelength range of normally 10 to 50 nm. In addition, with the DFB-LDs, the number of light sources is increased proportionally to the increase of a degree in the wavelength multiplicity, thereby leading to the increase in cost.

In order to solve the problems, there is a strong demand for attaining a wavelength-tunable light source usable with a single chip for a variety of wavelengths, instead of using a single semiconductor laser to unify all wavelengths in a WDM system. Such a wavelength-tunable light source is used not only as a light source of a commercial system but also as a backup light source adaptable for many wavelengths. When such a wavelength-tunable light source can be secured with a single chip, great advantages, for example, reduction in costs and miniaturization of devices can be obtained. In addition, this would play an important role to build an “all optical network” in a manner that a wavelength of an output laser beam of a semiconductor laser is changed to implement a wavelength routing to a different site of the network.

Conventionally, extensive researches have been conducted for various types of wavelength-tunable light sources that are capable of outputting many wavelengths with a single chip. Recently, developments are noticeable in the field of wavelength-tunable lasers in which movable mirrors utilizing a micro electro mechanical structure (MEMS) are integrated with a vertical cavity surface emitting laser (VCSEL) (see, for example, Non-Patent Reference Document 1).

A basic structure disclosed in Non-Patent Reference Document 1 is such that a polyimide layer is formed over an active layer, mirror layers of SiO₂/TiO₂ material are formed thereover, and the polyimide layer is then selectively removed, whereby an air gap is formed between an upper mirror and the active layer. When a voltage is applied between the upper mirror and a lower mirror, an electrostatic force is generated therein. By an electrostatic force generated, the upper mirror is attracted or repulsed, and the air gap is thereby varied, consequently causing the oscillation wavelength to be varied. In the case of the device structure of the vertical cavity surface emitting laser, a wavelength-tunable characteristic of 50 nm at an application voltage 40 V is reported. In the VCSEL structure, a laser resonator length is rendered variable to enable securing a wide wavelength-tunable range.

Another type disclosed is a wavelength-tunable semiconductor laser in which external resonator mirrors are deflected in a resonator direction parallel to a semiconductor substrate to cause an oscillation wavelength to be tunable (see, for example, Patent Reference Document 1).

Still another type disclosed is a technique in which a semiconductor laser oscillating with a single wavelength and a semiconductor optical amplifier are coupled together through an optical waveguide and the coupled devices are integrated on a same substrate. In this case, temperature control means of a semiconductor laser section is utilized to cause the wavelength to be tunable. (see, for example, Patent Reference Document 2) Yet another type disclosed is a technique in which a thin-film heater is mounted immediately above an upper electrode of a ridge-waveguide semiconductor laser or two sides of a ridge waveguide. In this case, an electric current to be applied to the heater is controlled, and an laser oscillation wavelength is thereby caused to be tunable. (see, for example, Patent Reference Document 3)

FIG. 15 is a principle-explanatory view of a Fabry-Perot (FP) resonator. For causing a laser beam light to steadily exist in the Fabry-Perot (FP) resonator, a standing wave is generated with a forward wave and a backward wave, and partially-transmissive mirrors opposing each other need to be disposed at positions corresponding to nodes. More specifically, a resonator length L corresponding to the intermirror distance is an integer multiple of the gap between the standing wave nodes, and a resonation condition of the Fabry-Perot (FP) resonator is expressed by a following equation:

$$2 L = N \frac{{λ}_{N}}{n} \qquad ( 1 )$$

where N is an integer, n is a refractive index in the resonator, L is a resonator length, and Δ_{N} is a wavelength of light.

When the resonator length is increased to L+ΔL and when the increase in the wavelength is represented by Δλ, the resonation condition is expressed by equation (2):

$$2 ( L + Δ L ) = N \frac{ {λ}_{N} + Δλ}{n} \qquad ( 2 )$$

The result of (2)-(1) is expressed as:

$$2 Δ L = N \frac{Δ λ}{n} \qquad ( 3 )$$

Equation (4) is obtained by deleting N from (1) and (3):

$$Δλ = \frac{Δ L}{L} λ \qquad ( 4 )$$

Equation (4) proves that the variation amount is proportional to ΔL/L. From this fact, a structure, as is in the VCSEL, enabling L to be reduced is effective to increase the wavelength-tunable range. For example, Δλ=52 nm is obtained when λ=1,550 nm, L=3 μm, and ΔL=0.1 μm. Another advantage in using the VCSEL is that a vertical mode gap is relatively wide, and a simplex mode oscillation can easily be implemented.

FIG. 16 is a model view of a vertical mode spectrum of the Fabry-Perot (FP) resonator. Since a transmittance of light increases upon resonation, resonant frequency peaks appear in a certain cycle. In the description hereinbelow, a standing wave pattern satisfying the resonation condition is referred to as a “vertical mode.” Similar to the cases of the equations (1) and (2), resonation conditions of λ_{N} and λ_{N+1} are expressed by equations (5) and (6):

$$\begin{matrix}2 L = N \frac{{λ}_{N}}{n} & ( 5 ) \\ 2 L = ( N + 1 ) \frac{{λ}_{N + 1}}{n} & ( 6 )\end{matrix}$$

According to equations (5) and (6), the vertical mode gap is expressed by equation (7):

$${λ}_{N} - {λ}_{N + 1} = \frac{2 n L}{N} - \frac{2 n L}{N + 1} = \frac{2 n L}{N ( N + 1 )} = 2 n L \frac{{λ}_{N}}{2 n L} \times \frac{{λ}_{N + 1}}{2 n L} \approx \frac{{λ}_{N}^{2}}{2 n L} \qquad ( 7 )$$

For example, when λ_{N}=1,550 nm, L=3 μm, and n=3.2, the vertical mode gap is 125 nm, in which a gap is wider than the gain band width, and an oscillation takes place in a simplex mode.

In addition, an advantage in using movable mirrors is that one voltage is sufficient to control the gap (i.e., air gap) of the movable mirrors, and the oscillation wavelength can easily be controlled.

Documents referenced hereinabove are as follows.

(Non-Patent Reference Document 1)

Electronics Letters, vol. 35, No. 11, May 27, 1999, pp. 900-901

(Patent Reference Document 1)

Japanese Unexamined Patent (Laid-open) Publication No. 10-209552 (FIG. 1)

(Patent Reference Document 2)

Japanese Unexamined Patent (Laid-open) Publication No. 2002-164615 (FIG. 1)

(Patent Reference Document 3)

Japanese Unexamined Patent (Laid-open) Publication No. 2000-294869 (FIG. 1)

However, the vertical cavity surface emitting laser disclosed in Non-Patent Reference Document 1 has problems such that an optical output power is as low as 2 mW. This output level is insufficient as compared to an optical output of 20 mW or higher that can be obtained from a nowadays simplex laser. Further, an integration process of the devices over a same substrate is complex.

Measures of increasing the optical output of the VCSEL include a technique that uses a semiconductor optical amplifier (SOA). However, in the case of integrating a semiconductor optical amplifier (SOA) and a wavelength-tunable laser in the same substrate, an amplifying medium length needs to be large to increase the amplification gain of the semiconductor optical amplifier. In this case, however, with the VCSEL type, since a laser beam light is perpendicularly irradiated over the substrate, and when attempting the integration over the substrate in the perpendicular direction, the film thickness cannot be increased to be larger than a certain level. This makes it difficult to integrate the constitution of the VCSEL type and the semiconductor optical amplifier (SOA) in the same substrate in the vertical direction.

In the structure disclosed in Patent Reference Document 1, external resonator mirror surfaces are heated and deformed utilizing a bending phenomenon caused by the heating. As such, an additional heating laser is required. This is drawback for control of the deformation amount.

In the structures disclosed in the Patent Reference Documents 2 and 3, the temperature control means is used to cause the oscillation wavelength to be tunable. In these cases, however, problems arise in that, for example, the responsive speed is low, and the optical output is varied according to variations in the oscillation wavelength.

### SUMMARY OF THE INVENTION

The present invention has been developed to solve these problems and has an object to provide a wavelength-tunable semiconductor optical device which is easy-to-manufacture, with a low-cost, high-speed, and small in size, having a wavelength-tunable semiconductor laser allowing the wavelength to be arbitrarily tuned using a movable mirror, wherein a semiconductor optical amplifier (SOA) and a wavelength-tunable laser are integrated in a same substrate in a resonant direction (i.e., direction horizontal to the substrate), and high laser outputs can be obtained.

In order to achieve the object described above, a wavelength-tunable semiconductor optical device according to the invention includes a resonator-dedicated semiconductor laser having a waveguide structure formed on a semiconductor substrate and a movable mirror which is movable in a resonator-lengthwise direction of the semiconductor laser. The movable mirror is provided on one end face of the waveguide of the semiconductor laser, and a resonator length of the semiconductor laser is varied in accordance with a movement amount of the movable mirror, whereby a laser oscillation wavelength is rendered tunable.

### BRIEF DESCRIPTION OF THE DRAWINGS

These and other objects and features of the present invention will be readily understood from the following detailed description taken in conjunction with preferred embodiments thereof with reference to the accompanying drawings, in which like parts are designated by like reference numerals and in which:.

FIG. 1 is an overall perspective view showing a basic structure of a semiconductor optical device according to an embodiment 1 of the present invention;

FIG. 2 is an overall perspective view illustrative of a manufacturing process for the semiconductor optical device according to the embodiment 1 of the invention;

FIG. 3 is an overall perspective view illustrative of a manufacturing process for the semiconductor optical device according to the embodiment 1 of the invention;

FIG. 4 is an overall perspective view illustrative of a manufacturing process for the semiconductor optical device according to the embodiment 1 of the invention;

FIG. 5 is an overall perspective view illustrative of a manufacturing process for the semiconductor optical device according to the embodiment 1 of the invention;

FIG. 6 is an overall perspective view illustrative of a manufacturing process for the semiconductor optical device according to the embodiment 1 of the invention;

FIG. 7A is an overall perspective view illustrative of a manufacturing process for the semiconductor optical device according to the embodiment 1 of the invention;

FIG. 7B is a top view of an essential portion of the semiconductor optical device as viewed from an upper portion to an end-face indicated by an arrow A in FIG. 7A;

FIG. 8A is an overall perspective view illustrative of a manufacturing process for the semiconductor optical device according to the embodiment 1 of the invention;

FIG. 8B is a top view of an essential portion of the semiconductor optical device as viewed from an upper portion to an end-face indicated by an arrow A in FIG. 8A;

FIG. 9A is an overall perspective view illustrative of a manufacturing process for the semiconductor optical device according to the embodiment 1 of the invention;

FIGS. 9B and 9C are top views each showing an essential portion of the semiconductor optical device as viewed from an upper portion to an end-face indicated by an arrow A in FIG. 9A;

FIG. 10A is an overall perspective view illustrative of a manufacturing process for the semiconductor optical device according to the embodiment 1 of the invention;

FIG. 10B is a top view of an essential portion of the semiconductor optical device as viewed from an upper portion to an end-face indicated by an arrow A in FIG. 10A;

FIG. 11A is an overall perspective view illustrative of a manufacturing process for the semiconductor optical device according to the embodiment 1 of the invention;

FIG. 11B is a top view of an essential portion of the semiconductor optical device as viewed from an upper portion to an end-face indicated by an arrow A in FIG. 11A;

FIG. 12 is an overall vertical cross-sectional view schematically showing a basic structure of a semiconductor optical device according to an embodiment 2 of the invention;

FIG. 13 is an overall vertical cross-sectional view schematically showing a basic structure of a semiconductor optical device according to an embodiment 3 of the invention;

FIG. 14 is an overall vertical cross-sectional view schematically showing a basic structure of a semiconductor optical device according to an embodiment 4 of the invention;

FIG. 15 is a principle-explanatory view of a Fabry-Perot (FP) resonator; and

FIG. 16 is a model view of a vertical mode spectrum of the Fabry-Perot (FP) resonator.

### DETAILED DESCRIPTION OF THE PREFERRED EMBODIMENTS

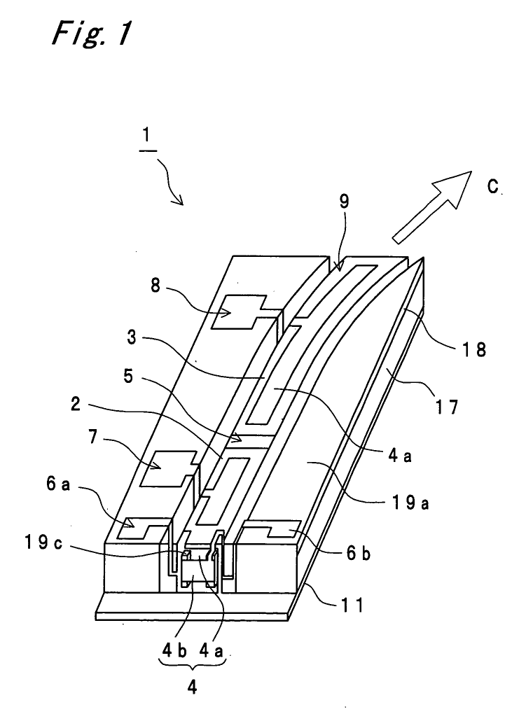

Embodiments of the invention will be described hereinbelow with reference to FIGS. 1 to 14. Common or like components and elements are designated by the same reference numerals or symbols throughout the drawings, and repetitive descriptions therefor will be omitted for purpose of simplicity.

(Embodiment 1)

A semiconductor optical device according to an embodiment 1 of the invention will be described hereinbelow with reference to FIGS. 1 to 11.

FIG. 1 is an overall perspective view depicting a basic structure of a semiconductor optical device 1 according to an embodiment 1 of the invention. In the basic structure shown in FIG. 1, a semiconductor laser section (LD) 2 and a semiconductor optical amplifier (SOA) 3 are disposed and integrated on a same chip substrate in a light propagation direction using a butt joint growth. Power is fed to the semiconductor laser section 2 and semiconductor optical amplifier 3 via a laser power feed electrode 7 and optical-amplifier power feed electrode 8, respectively. The semiconductor laser section 2 and the semiconductor optical amplifier 3 may share the same active layer to constitute an optical waveguide 9. An end portion of the semiconductor optical amplifier 3, which is an output end portion of the optical waveguide for outputting a laser beam (light C), is formed in a structure of an embedded window of a bent waveguide. Thus, an end-face reflectance is reduced to thereby prevent occurrence of reflection returning light.

A movable mirror 4 is integrated on one end face 2a opposing the output end portion of the semiconductor laser section 2 for outputting the laser light C. The movable mirror 4 is movably adjustable in the direction horizontal to the substrate (i.e. direction of the resonator length). The movable mirror 4 is structured by bonding a pair of metal reflectors (a first metal layer 4a and a second metal layer 4b, which will be described later). These metal reflectors are spaced away to oppose each other at a predetermined distance via an air gap. For example, the first metal layer 4a is fixed at a predetermined position, and the second metal layer 4b is disposed to be movably adjustable. A material having a high light reflectance is used for the metal reflectors.

In a preferred embodiment, each of the reflector films is formed by conducting vapor deposition of a metal film, such as aluminum, to increase the light reflectance. The structure may be arranged such that the vapor-deposited metal film having a reflectance of 30% or higher is formed on the reflection-section end face. Other usable metal materials for the reflector film are, for example, titanium, chromium, gold, platinum and nickel. The first and second metal reflectors 4a and 4b are, respectively, coupled to a pair of first and second mirror-moving electrodes 6a and 6b to receive voltage application for moving the mirror. A reflection face position of the second metal reflector 4b is movably adjusted by an electrostatic force generated upon the voltage application.

A resonator length L of the semiconductor laser section 2 is adjusted by changing the distance of an air gap formed between the second metal reflector 4b of the movable mirror 4 and the first metal reflector 4a fixed on the end face 2a of the semiconductor laser section 2. In the present embodiment, the resonator length L of the semiconductor laser section 2 is set to a range of 5 to 100 μm, which is shorter than that in an ordinary semiconductor laser. The length is thus set for the reason that, as shown by the equation (4), the smaller resonator length L enables the larger wavelength-tunable width to be secured.

In this structure, an isolation groove 5 having a substantially rectangular concave portion in cross-section is formed by etching regions between the semiconductor laser section 2 and the semiconductor optical amplifier section 3. Thereby, the semiconductor laser section 2 and the semiconductor optical amplifier 3 are spaced away from each other at a predetermined distance, and a difference (mismatch) is set between refractive indexes of the two sections. Consequently, reflection light is generated in the isolation groove 5. This causes a mode oscillation of a Fabry-Perot (FP) resonator in the semiconductor laser section 2. In this construction, the Fabry-Perot (FP) resonator may be a multilayered reflector film structure formed such that, for example, layers of SiO₂ and silicon are laminated over a light emission surface and a light incident surface of the semiconductor laser section 2. For the light to stably exist in the Fabry-Perot (FP) resonator, the disposition positions of mirrors opposing each other are set to correspond to nodes, and the resonator length L is set to be an integer multiple of the gap between the standing wave nodes.

<Operational Principle>

Referring to FIG. 1, the operational principle of the wavelength tunability is as follows. Voltage is applied to the two mutually opposite metal reflectors 4a and 4b formed on the end face 2a of the semiconductor laser section 2 via the respective first and second mirror-moving electrodes 6a and 6b. This causes an electrostatic force to be generated between the metal reflectors 4a and 4b. The electromotive force causes the metal reflection reflectors 4a and 4b to be mutually attracted or repulsed. Thereby, the air gap (4d) distance between the two metal reflectors 4a and 4b, which will be described later, is varied to cause the oscillation wavelength of the laser resonator to be tunable.

<Manufacturing Method>

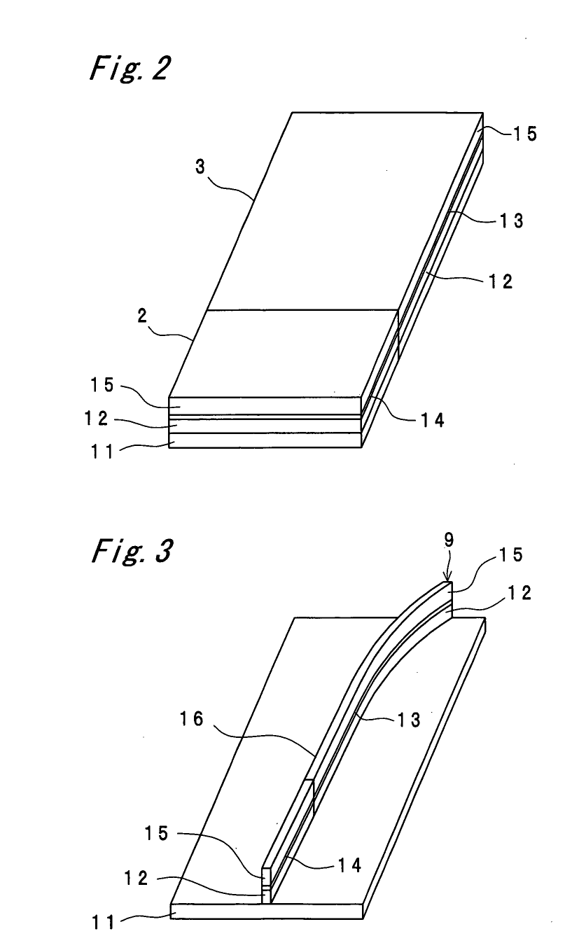

FIGS. 2 to 11 show individual procedures of a manufacturing method of the semiconductor optical device according to the embodiment 1. The manufacturing method shown in FIGS. 2 to 11 is used to manufacture a monolithically integrated semiconductor optical device. In the semiconductor optical device, the wavelength-tunable semiconductor laser (LD) and the semiconductor optical amplifier (SOA) are integrated in the same chip substrate. In addition, the movable mirror having the reflection face position that is movably adjustable is integrated on the one end face of the semiconductor laser in the direction of the laser resonator length (horizontal, longitudinal direction with respect to the substrate).

(1) Forming Laser Active Layer and Optical Amplifier Layer

Referring to FIG. 2, a first conductive (n-type) InP clad layer 12, an laser active layer 14, and a second conductive (p-type) InP clad layer 15 are formed in that order over an upper surface of a first conductive (n-type) InP substrate 11 to thereby form a laminated semiconductor laser section 2. Thereafter, all regions other than the laminated region of the semiconductor laser section 2 are removed. Then, an InP clad layer 12, an optical amplifier layer 13, and an InP clad layer 15 are formed in that order over the InP substrate 11 to thereby form a laminated semiconductor optical amplifier 3. The laser active layer 14 of the semiconductor laser section 2 is formed to the same level in depth (height) as that of the optical amplifier layer 13 of the semiconductor optical amplifier 3. Alternatively, the optical amplifier layer 13 and the laser active layer 14 may be formed of the same active layer.

(2) Forming Optical Waveguide Ridge

As shown in FIG. 3, an insulation film 16 for forming an optical-waveguide ridge is formed in a stripe shape on the InP clad layer 15. Only the laminated region covered by the ridge forming insulation film 16 on the substrate 11 is remained, and the other laminated regions are removed. Thereby, an optical waveguide ridge 9 is formed of the InP clad layer 12, laser active layer 14, InP clad layer 15, and ridge forming insulation film 16 in the semiconductor laser section 2. The waveguide ridge 9 has a width of 1 to 2 μm and a depth (height) of 1 to 4 μm. In a similar manner, an optical waveguide ridge 9 is formed of the InP clad layer 12, optical amplifier layer 13, InP clad layer 15, and ridge forming insulation film 16 in the semiconductor optical amplifier 3.

(3) Embedding Growth

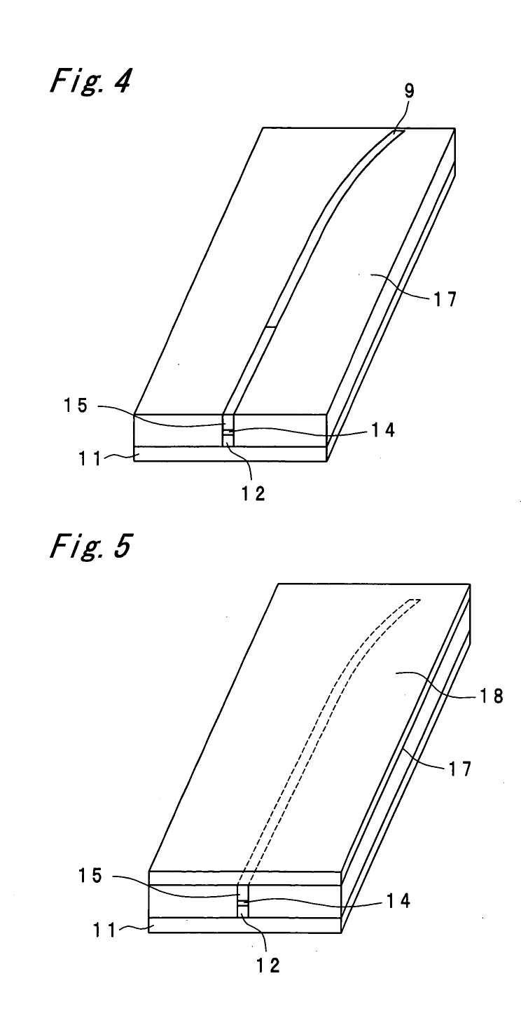

As shown in FIG. 4, an InP embedding layer 17 is formed by embedding growth on the both sides of the waveguide ridge 9. The structure of the embedding layer 17 may be a p-InP/n-InP multilayer structure, or may be a structure including a semi-insulative InP layer.

(4) Forming Contact Layer

As shown in FIG. 5, after the ridge forming insulation film 16 has been removed, a second conductive (p-type) contact layer 18 is formed over the waveguide ridge 9 and an upper surface of the InP embedding layer 17.

(5) Forming Isolation Mesa

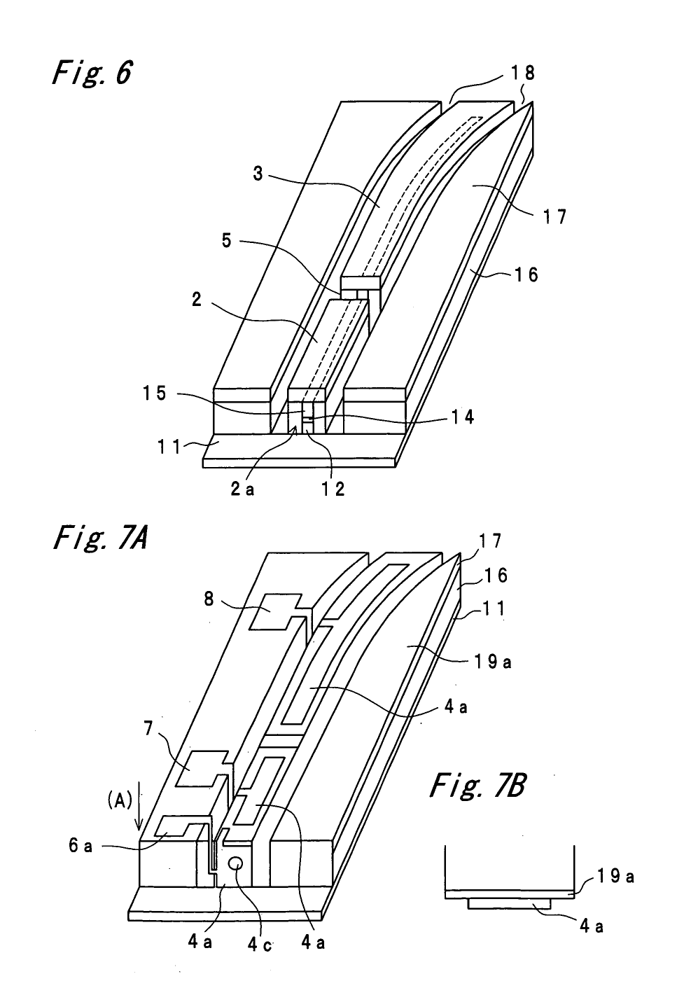

As shown in FIG. 6, to provide a device-isolation mesa structure, an isolation groove 5 is formed by dry etching to extend to two sides of the end face 2a side of the semiconductor laser section 2 and two sides of the waveguide region and between the semiconductor laser section 2 and the semiconductor optical amplifier 3. In this manner, the predetermined regions of the semiconductor substrate 11 are dry-etched, and a reflecting region is thereby formed as a rectangular grooved concave region.

(6) Forming Contact Electrodes

FIG. 7A is a perspective view for explaining a process of forming contact electrodes. FIG. 7B is an enlarged top view showing an essential portion of the semiconductor optical device as viewed from an upper portion to an end-face indicated by an arrow A in FIG. 7A. As shown in FIGS. 7A and 7B, a first insulation film layer 19a is formed overall on the semiconductor optical device for acting as a passivation as well as anti-reflection coating of the end face of the semiconductor laser section 2. An opening is formed in a region where the contact electrode of the first insulation film layer 19a is formed (not shown). Thereafter, a first metal reflection layer 4a, a first mirror-moving electrode 6a, and power-feel electrodes 7 and 8 are formed at the same time on the upper surface regions of the waveguide and the end face 2a region of the semiconductor laser section. The first metal layer 4a formed on the end face of the semiconductor laser section is connected to the first mirror-moving electrode 6a. An opening 4c is formed in a region corresponding to the active layer 14 of the end face 2a, thereby enabling a laser beam to be emitted and passed therethrough. The “contact electrodes” refer to regions (hatched regions in FIG. 7A) of the first metal reflection layer 4a, where the upper semiconductor portions of the semiconductor laser (LD) and the semiconductor optical amplifier (SOA) are to be in direct contact with the metal layer.

(7) Forming Sacrificial Layer

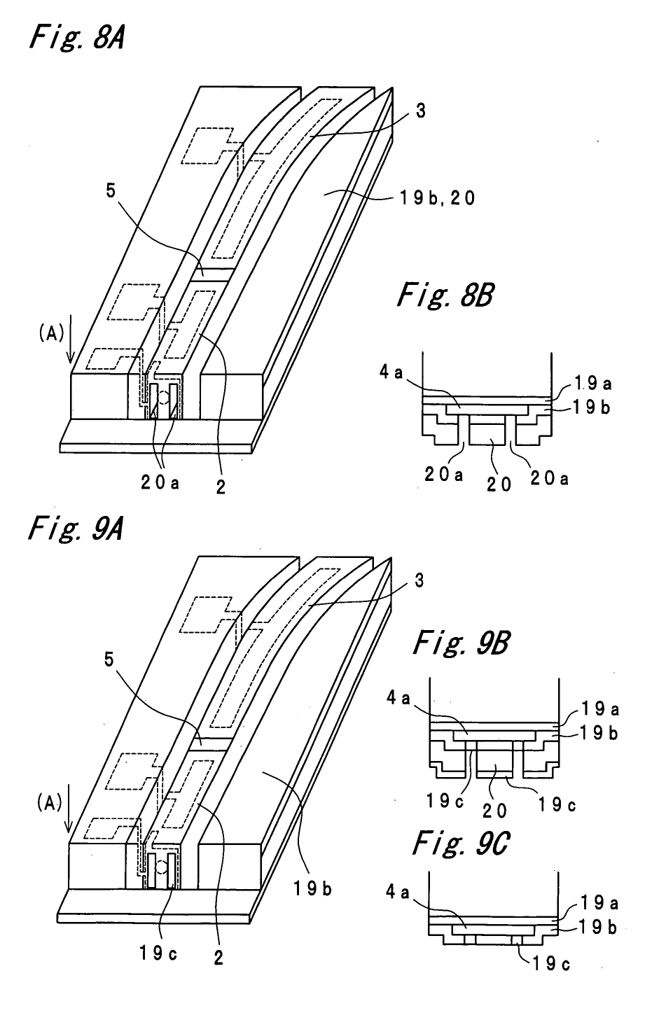

FIG. 8A is a perspective view for explaining a process of forming a sacrificial layer. FIG. 8B shows a top view of an essential portion of the semiconductor optical device as viewed from an upper portion to an end-face indicated by an arrow A in FIG. 8A. As shown in the drawings, a second insulation film layer 19b serving as a sacrificial layer is formed overall on the upper surface and end face of the semiconductor optical device. Then, patterning is performed with a photoresist 20 to form openings 20a on the end face 2a of the semiconductor laser section 2, and the second insulation film layer 19b portions within the openings 20a are selectively removed by etching. The openings 20a are used as opening portions for providing a third insulation film 19c used for mirror holding insulation, which will be described below.

(8) Forming Mirror-Holding Insulation Films)

FIG. 9A is a perspective view for explaining a process of forming mirror-holding insulation films. FIGS. 9B and 9C show top views of essential portions of the semiconductor optical device as viewed from an upper portion to an end-face indicated by an arrow A in FIG. 9A. As shown in FIG. 9B, in the state that the photoresist 20 has been formed, the third insulation films 19c is formed on the end face of the laser waveguide and bottom faces of the openings 20a. These third insulation films are used as mirror-holding insulation films. The third insulation film 19c may be of the same material as that of the first insulation film layer 19a. Subsequently, as shown FIG. 9C, the photoresist 20 is removed in a lift-off manner. Consequently, the regions of the third insulation films 19c formed in the bottom portions of the openings 20a are remained in the form of a pair of the mirror-holding insulation film regions.

(9) Forming Mirror Electrodes

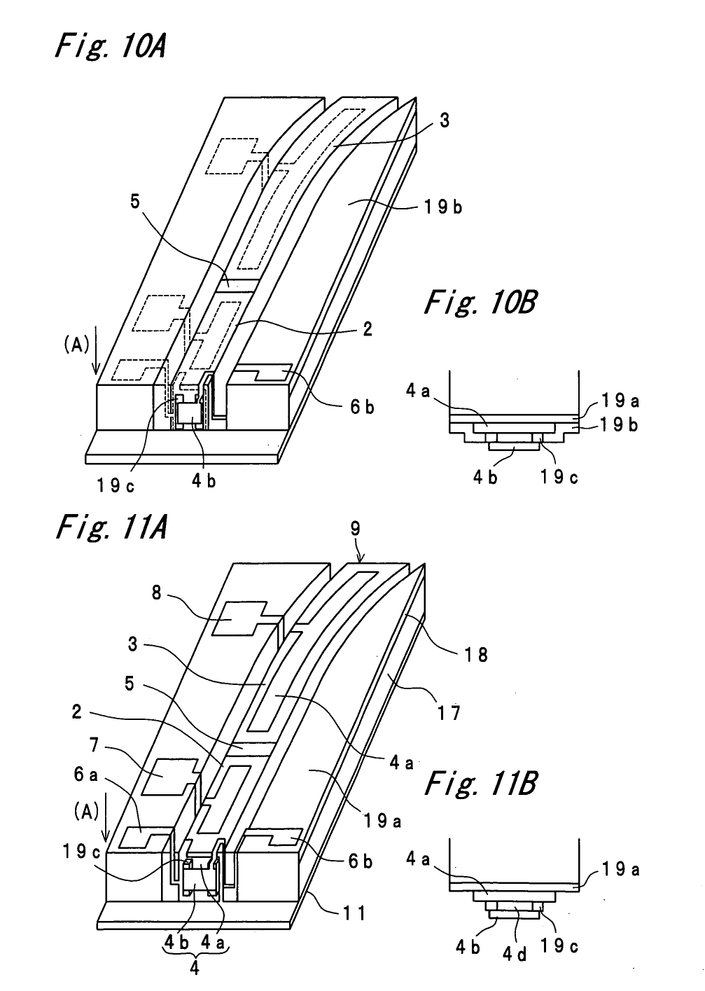

FIG. 10A is a perspective view for explaining a process of forming a mirror electrode. FIG. 10B shows a top view of an essential portion of the semiconductor optical device as viewed from an upper portion to an end-face indicated by an arrow A in FIG. 10A. As shown in the drawings, the second mirror-dedicated electrode 6b is formed in a position substantially symmetric with a position of the first mirror-dedicated electrode 6a in such a manner as to interpose the waveguide. Then, the second metal layer 4b is formed so as to overlap with the region of the second insulation film layer 19b (sacrificial layer), which is formed in a central portion of the end face of the semiconductor laser section, and the upper surface regions of the mirror-holding insulation film 19c. Thereby, the second metal layer 4b and the second mirror-dedicated electrode 6b are connected or integrally formed. Two right and left ends of the second metal layer 4b are fixedly held by the third insulation films 19c. In this manner, a pair of the third insulation film portions 19c work as “bridge piers” that fixedly hold the second metal layer 4b as the movable mirror.

(10) Removing Sacrificial Layer

FIG. 11A is a perspective view for explaining removal of the sacrificial layer. FIG. 11B shows a top view of an essential portion of the semiconductor optical device as viewed from an upper portion to an end-face indicated by an arrow A in FIG. 11A. As shown in the drawings, the sacrificial layer, namely, the second insulation film layer 19b, is selectively removed. Consequently, the movable mirror 4 is formed that is constituted of the thin metal films 4a and 4b mutually opposite via the paired third insulation films 19c. The structure includes a predetermined air gap (cavity) 4d formed by the removal of the sacrificial layer to intervene between the thin metal films 4a and 4b.

The technique of removing the second insulation film layer 19b (sacrificial layer) depends on the cases. For example, in the case where SiO₂ material is used for the first insulation film layer 19a and the third insulation film 19c and SiN material is used for the second insulation film layer 19b, the etching rate with respect to plasma etching for SIN is a higher in comparison to that for SiO₂ than that for SiO₂. Therefore, the SiN material (i.e., second insulation film layer 19b) can be selectively removed using the plasma etching.

Alternatively, in the case where SiN material is used for the first insulation film layer 19a and the third insulation film 19c and SiO₂ material is used for the second insulation film layer 19b, the etching rate for SiO₂ with respect to wet etching is a higher than that for SiN. Therefore, the SiO₂ material (i.e., second insulation film layer 19b) can be selectively removed using the wet etching.

(11) Steps for Reverse Surface

The substrate 11 is polished and thereby thinned to about 100 μm, and electrodes (not shown) are formed on the reverse surface thereof. The sacrificial layer (19b) may be removed after the step for the reverse surface has been performed.

According to the structure described above, the oscillating laser light emitted from the active layer 14 of the semiconductor laser is reflected by the second thin metal layer 4b of the movable mirror 4, and is returned to the active layer 14. Then, the position of the second thin metal layer 4b is movably adjusted by an electrostatic force generated with voltage application, thereby enabling the laser oscillation wavelength to be tuned. Consequently, there can be obtained a wavelength-tunable semiconductor laser optical device attaining high laser outputs with an easy-to-manufacture and at a low cost.

(Embodiment 2)

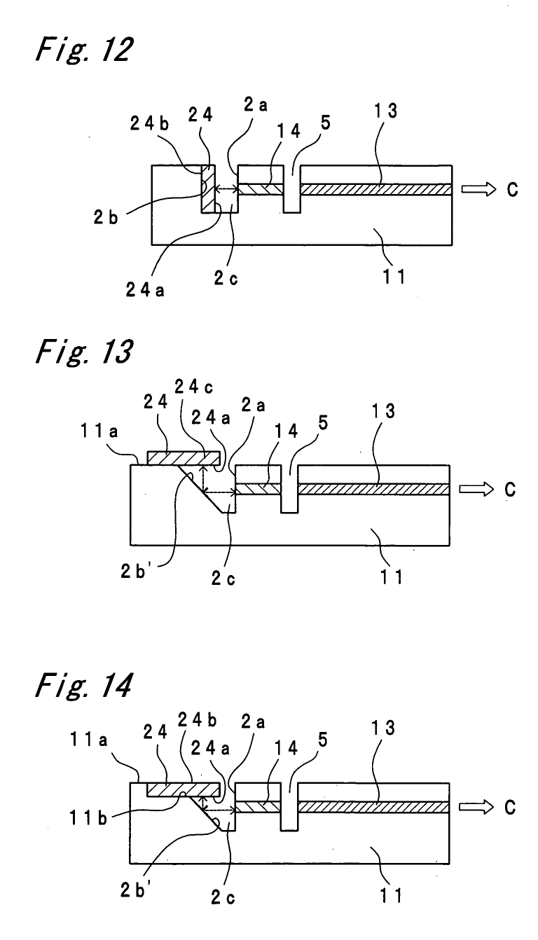

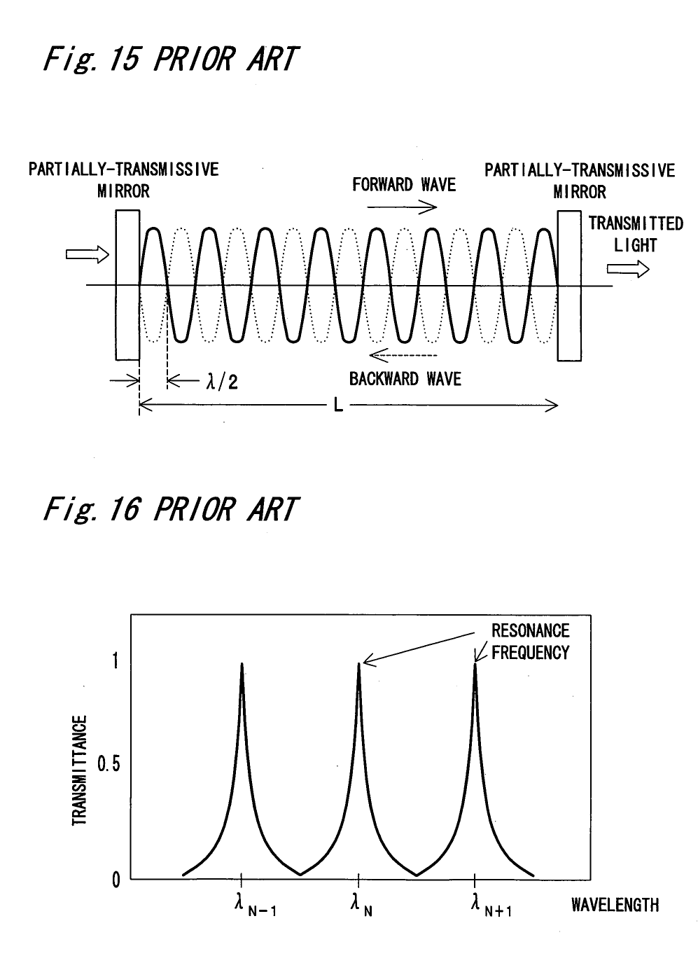

A semiconductor optical device of an embodiment 2 according to the invention will be described hereinbelow with reference to FIG. 12. FIG. 12 is an overall vertical cross-sectional view schematically showing a basic structure of a semiconductor optical device according to the embodiment 2. The basic structure, operational principles, and manufacturing method of the embodiment 2 are similar to those of the embodiment 1. The embodiment 2 is a modification different from the embodiment 1 in the following aspects. According to the embodiment 1 illustrated in FIG. 1, the movable mirror 4 is directly fixed to the waveguide end face 2a of the semiconductor laser section to be integrated. In contrast, the embodiment 2 is different in that a concave region 2c having a substantially rectangular cross-sectional shape is formed in the substrate 11 on the side of laser oscillation light emission, and a movable mirror 24 is fixedly disposed on an end face (2b) opposing the waveguide end face 2a in the concave region 2c. Similar to the structure of the embodiment 1, the movable mirror 24 may be constituted of a pair of metal reflectors opposing each other via an air gap, in which the one reflector is fixed at a predetermined position and the other reflector is set to be movably adjustable.

In more specific, in the embodiment 2, the concave region 2c formed in the substrate has a vertical face 2b opposite the waveguide end face 2a and perpendicular to the substrate surface. A reflector end face 24b on the one side of the movable mirror 24 is fixedly disposed to the vertical face 2b of the concave region. Concurrently, a reflector end face 24a on the other side of the movable mirror 24 is set movable by a technique similar to that in the embodiment 1.

According to the structure described above, oscillating laser light emitted from the active layer 14 is reflected by the reflector end face 24b of the movable mirror 24, and is returned to the active layer 14. Then, the position of the reflector end face 24a is movably adjusted using a similar technique in the embodiment 1. Consequently, there can be obtained a wavelength-tunable semiconductor laser optical device in which the laser oscillation wavelength is tunable.

With the structure described above, not only advantages similar to those of the embodiment 1, but also other advantages can be obtained in that, since the movable mirror is embedded in the concave region of the substrate 11, reflecting faces are not exposed to the outside. Accordingly, the reflector film is prevented from deterioration, and is protected from damage caused in contact with external members. Further, since the movable mirror is embedded in the substrate, the size (thickness) of the semiconductor optical device in the height-direction can be reduced, consequently enabling the device to be miniaturized.

(Embodiment 3)

A semiconductor optical device of a embodiment 3 according to the invention will be described hereinbelow with reference to FIG. 13. FIG. 13 is an overall vertical cross-sectional view schematically showing a basic structure of a semiconductor optical device according to the embodiment 3. The basic structure and operational principles of the embodiment 3 are similar to those of the embodiment 2. The embodiment 3 is different from the embodiment 2 in the following aspects. The movable mirror 24 is disposed on the substrate surface to be parallel to the substrate surface (i.e., in the horizontal direction). A hollow concave region 2c having a cross-sectional shape of a substantially reversed trapezoid is formed in the substrate. The hollow concave region 2c has a sloped face 2b′ formed with a tilt angle of substantially 45° in a position opposite to the waveguide end face 2a of the semiconductor laser section. In the structure thus formed, the laser light reflected by the sloped face 2b′ is reflected by a reflecting face 24a of the movable mirror 24. Similar to the structure of the embodiment 1, the movable mirror 24 may be constituted of a pair of metal reflectors opposing each other via an air gap, in which the one reflector is fixed at a predetermined position and the other reflector is set to be movably adjustable.

Referring to a method of providing the movable mirror 24, a hollow concave region 2c is first formed in the substrate, which is defined between the waveguide end face 2a of the semiconductor laser section and the sloped face 2b′. Then, a polyimide filler material is filled into the hollow concave region 2c, one end portion of the movable mirror 24 is fixed to an upper surface 11a of the substrate, which is positioned above the sloped face 2b′. The other end portion of the movable mirror 24 is set to be a free end which is parallel to the longitudinal direction of the substrate. Consequently, the lower-end reflecting face 24a is positioned at the same height level as the upper surface 11a. After the movable mirror 24 has been fixed, the filled polyimide filler material is removed to form a movable-mirror crossbeam-like free end portion 24c protruding above the hollow concave portion 2c.

As described above, according to the embodiment 3, the sloped face 2b′ formed in the substrate 11 is used as a reflecting face for the laser light in the vicinity of the waveguide end face 2a of the semiconductor laser. The reflecting face 2b′ is used to change the propagation direction of the light to the direction perpendicular to the substrate surface. The lower side reflecting face 24a of the movable-mirror crossbeam-like free end portion 24c, which protrudes horizontally above the hollow concave region 2c of the movable mirror 24, is movably adjusted according to a method similar to that in the embodiment 1. Consequently, there can be obtained a wavelength-tunable semiconductor laser optical device in which the laser oscillation wavelength is tunable.

Thus, the movable mirror 24, which is movable perpendicular to the substrate, is formed over the horizontal surface parallel to the substrate surface, and the movable mirror is used as a reflecting mirror. Consequently, the laser oscillation wavelength can be tuned corresponding to the movable distance of the movable mirror.

With the structure described above, after the laser oscillation light emitted from the active layer 14 is reflected by the sloped face 2b′, the light is reflected by the reflecting face 24a of the movable mirror 24 and is thereafter returned to the active layer 14. Thus, the position of the reflecting facet 24a is movably adjusted, and, similar to the cases of the embodiments 1 and 2, the laser oscillation wavelength is tunable to thereby maintain a wide wavelength-tunable range.

(Embodiment 4)

A semiconductor optical device of an embodiment 4 according to the invention will be described hereinbelow with reference to FIG. 14. FIG. 14 is an overall vertical cross-sectional view schematically showing a basic structure of a semiconductor optical device according to the embodiment 4. The basic structure and operational principles of the embodiment 4 are similar to those of the embodiment 3. The embodiment 4 is different in that the movable mirror 24 is embedded in the substrate to be parallel to the substrate surface.

In more specific, a stepped flat region 11b is formed on an upper region of the sloped face 2b′ of the hollow concave region 2c which has a substantially reversed trapezoidal shape in cross-section. A rear end portion of the lower reflecting facet 24a of the movable mirror 24 is fixed onto the stepped flat region 11b. In this manner, the movable mirror 24 is placed more inwardly than the substrate surface 11a and to be parallel to the substrate surface. In this case, an upper surface 24b of the movable mirror 24 is set in the same height level as the substrate surface 11a. Other portions of the structure, the operational principles, and the procedure of mounting the movable mirror 24 are similar to those in the embodiment 3.

According to the embodiment 4, similar advantages as those of the embodiment 3 can be secured. In addition, since the movable mirror is embedded in the substrate, and the region in the thickness direction of the movable mirror is not convex with respect to the upper region of the substrate surface. Consequently, the size (thickness) in height-direction can be reduced.

As described above, according to the present invention, the substrate and the optical waveguide are formed of the semiconductor materials, and a movable mirror is used to thereby realize a wide wavelength-tunable range in the wavelength-tunable semiconductor optical device.

Although the present invention has been described in connection with the preferred embodiments thereof with reference to the accompanying drawings, it is to be noted that various changes and modifications will be apparent to those skilled in the art. Such changes and modifications are to be understood as included within the scope of the present invention as defined by the appended claims, unless they depart therefrom.

What is claimed is:

1. A wavelength-tunable semiconductor optical device comprising:
a resonator-dedicated semiconductor laser having a waveguide structure formed on a semiconductor substrate; and
a movable mirror which is movable in a resonator-lengthwise direction of the semiconductor laser,
wherein the movable mirror is provided on one end face of the waveguide of the semiconductor laser, and a resonator length of the semiconductor laser is varied in accordance with a movement amount of the movable mirror, whereby a laser oscillation wavelength is rendered tunable.

2. A wavelength-tunable semiconductor optical device comprising:
a resonator-dedicated semiconductor laser having a waveguide structure formed on a semiconductor substrate; and
a movable mirror which is movable in a resonator-lengthwise direction of the semiconductor laser,
wherein the movable mirror is provided on an inner wall of a concave region within the semiconductor substrate opposing to one end face of the waveguide of the semiconductor laser, and a resonator length of the semiconductor laser is varied in accordance with a movement amount of the movable mirror, whereby a laser oscillation wavelength is rendered tunable.

3. A wavelength-tunable semiconductor optical device comprising:
a resonator-dedicated semiconductor laser having a waveguide structure formed on a semiconductor substrate; and
a movable mirror which is movable in a direction perpendicular to a surface of the semiconductor substrate,
wherein the semiconductor substrate includes a concave region which is partly defined by a sloped face located in the vicinity of one end face of a laser light emission side of the semiconductor laser waveguide, so that a propagation direction of irradiation laser light from the one end face of the waveguide is varied to a direction perpendicular to the semiconductor substrate by reflection on the sloped face,
wherein the movable mirror is partially fixed to an upper portion of the sloped face, and a resonator length of the semiconductor laser is varied in accordance with a movement amount of the movable mirror, whereby a laser oscillation wavelength is rendered tunable.

4. The wavelength-tunable semiconductor optical device according to claim 3, wherein an upper region of the sloped face has a stepped flat region which is parallel to the semiconductor substrate, so that the movable mirror is partially fixed onto the stepped flat region.

5. The wavelength-tunable semiconductor optical device according to claim 1, wherein the movable mirror is comprised of a pair of thin metal films opposing each other via an air gap.

6. The wavelength-tunable semiconductor optical device according to claim 1, wherein the semiconductor laser is coupled to a semiconductor optical amplifier through the optical waveguide via an isolation groove so that the coupled semiconductor laser and the semiconductor optical amplifier are integrated on the semiconductor substrate.

7. The wavelength-tunable semiconductor optical device according to claim 1, wherein the resonator length of the semiconductor laser is 100 μm or less.
